(19) United States
(12) Patent Application Publication
(10) Pub. No.: US 2017/0178151 A1
(43) Pub. Date: Jun. 22, 2017

(54) SYSTEMS AND METHODS FOR EXTRAPOLATION OF MARKET RESEARCH DATA

(71) Applicant: SAP SE, Walldorf (DE)

(72) Inventors: Pamela Sharma, Speyer (DE); Hergen Busch, Heidelberg (DE); Alexander Grendel, Bad Schonborn (DE)

(21) Appl. No.: 14/974,037

(22) Filed: Dec. 18, 2015

(51) Int. Cl. G06Q 30/02

(52) U.S. Cl. CPC G06Q 30/0201

(57) ABSTRACT

A method for extrapolating product market research data includes determining whether the market research data for two or more products includes a complete time series data set, for each product with a complete time series data set, performing a trend analysis on the obtained market research data for a respective product, and for each of the two or more products with an incomplete time series data set, applying one set of weighting factors. Decomposing the obtained market research data for the respective product into at least an unexplainable remainder, comparing the unexplainable remainder to a predetermined threshold, and either extrapolating the time series data of the respective product using an optimized triple exponential smoothing algorithm, or applying the one set of weighting factors for the time series data of the respective product. A system to implement the method and a non-transitory computer-readable medium are also disclosed.

### BACKGROUND

A business can rely on marketing information to plan its operations. Past performance can be determined from reported data in combination with an extrapolation of that performance to close any gaps in the data for periods not yet available for reporting—e.g., for the past month. For example, a manufacturing company with a global marketing department might be interested in global reporting on its product retail sales. The global reporting can be provided by data services that accumulate market research in databases.

The data, as provided, can be suitable for detailed local-market share analysis for the region(s) and/or country(ies) represented in that data. For local reporting different delivery schedules and time granularities are no issue because data can get reported simply when it is available in the system. But in a company with a global marketing department that is interested in global reporting, a cumulative world-wide report could need reports from several databases at once. Usually, the data services maintain information in their databases at one granularity of time intervals that are dependent on the industry reporting conventions of the local marketplace. Working across different databases comes with a number of challenges. For example, databases maintained by different providers (and of different regions) can have different data delivery cycles. Additionally, the data itself could represent different time granularities—e.g., weekly, four-weekly, monthly, bimonthly, etc. Different delivery cycles is a consequence of the databases having different time granularities—for example, a database with bi-monthly data can be provided only every two months (i.e., six times a year). However, a database containing weekly data could get theoretically provide the latest data every week. In practice, weekly data is provided twelve times a year on a 4-4-5 or 5-4-4 pattern to bundle the last four to five new weeks.

Using SAP Demand Signal Management (SAP DSiM), a manufacturer, or any user, can extrapolate data points that are not yet available to fill gaps in the reported data. Conventionally, the extrapolation of market research data to fill the reporting gaps could be based on weighting factors. To reflect seasonal deviations in product sales, a user can define weighting factors for the corresponding periods. Conventionally, one set of weighting factors can be assigned to one, or several, databases. By using one set of weighting factors for one database all products will get extrapolated with the same seasonal sales pattern that is described by the weighting factors. However within one database, different product categories could be provided where the products have completely different seasonal deviations in sales. Such compensation of inter-product seasonal deviations by the same weighting factors can introduce inaccurate or less precise values into the extrapolated data.

At a product level the result of this extrapolation method might be insufficient as the pattern of the weighting factors might not reflect the seasonal deviation of the product. If all products have the same extrapolation calculation, relative key parameters, such as market share, will not change for the extrapolated periods. To assign multiple sets of weighting factors to a database to handle individual seasonal deviations of each product results in an enormous volume of data weighting factors. This large volume of data is a cost driver increase to users. Additionally, the transparency of how the extrapolation is executed is further decreased by determining, calculating, and applying individual seasonal deviations for each product at each database.

### BRIEF DESCRIPTION OF THE DRAWINGS

FIG. 1 depicts a system for extrapolation of market research data in accordance with embodiments;

FIG. 2 depicts a conventional data aggregation timeline;

FIGS. 3A-3B depict an exemplar conventional extrapolation for two separate products from the same database;

FIG. 4 depicts a process for extrapolating market research data in accordance with embodiments; and

FIGS. 5A-5B depict an exemplar extrapolation result for two separate products from the same database performed by the process of FIG. 4 in accordance with embodiments.

### DETAILED DESCRIPTION

In accordance with embodiments, systems and methods provide product-specific extrapolation that uses triple exponential smoothing implemented using a predictive analysis library component of a relational database management system. This product-level simple extrapolation for each product is achieved without any additional data maintenance, and free of the need for persistence of weighting factors.

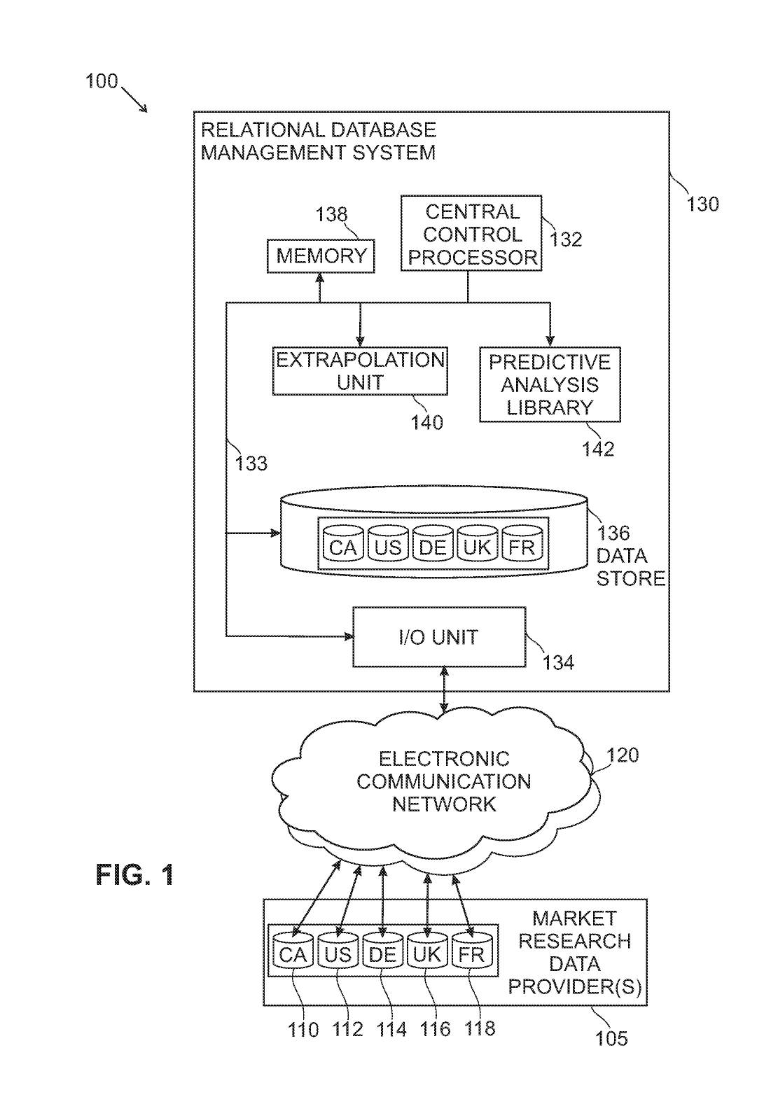

FIG. 1 depicts system 100 for extrapolation of market research data in accordance with embodiments. System 100 includes one or more market research data providers 105. Each of the market research data providers can be located in different region(s) or country(ies). Data providers 110, 112, 114, 116, 118 can each provide market data obtained from different regions (e.g., Canada, U.S., Germany, U.K., France, etc.). System 100 also can include relational database management system (RDBMS) 130. The RDBMS includes input/output unit 134, which is in communication with one or more of data providers 110, 112, 114, 116, 118 across electronic communication network 120.

Electronic communication network 120 can be, can comprise, or can be part of, a private internet protocol (IP) network, the Internet, an integrated services digital network (ISDN), frame relay connections, a modem connected to a phone line, a public switched telephone network (PSTN), a public or private data network, a local area network (LAN), a metropolitan area network (MAN), a wide area network (WAN), a wireline or wireless network, a local, regional, or global communication network, an enterprise intranet, any combination of the preceding, and/or any other suitable communication means. It should be recognized that techniques and systems disclosed herein are not limited by the nature of network 120.

RDBMS 130 can include central control processor 132 running computer executable instructions. The executable instructions can be stored locally in memory 138, and/or accessible over electronic communication network 120 from an external memory unit. The central control processor may be a processing unit, a field programmable gate array, discrete analog circuitry, digital circuitry, an application specific integrated circuit, a digital signal processor, a reduced instruction set computer processor, etc. Memory 138 can include internal memory (e.g., volatile and/or non-volatile memory devices).

The components of RDBMS 130 are in communication with the central control processor over bus 133. These components can include data store 136, which contains data received from data providers 110, 112, 114, 116, 118. The RDBMS also can include extrapolation unit 140 and predictive analysis library 142. Extrapolation unit 140 can access the aggregated data from data store 136, and predictive algorithms from the predictive analysis library to perform extrapolation algorithms on market research data in accordance with embodiments.

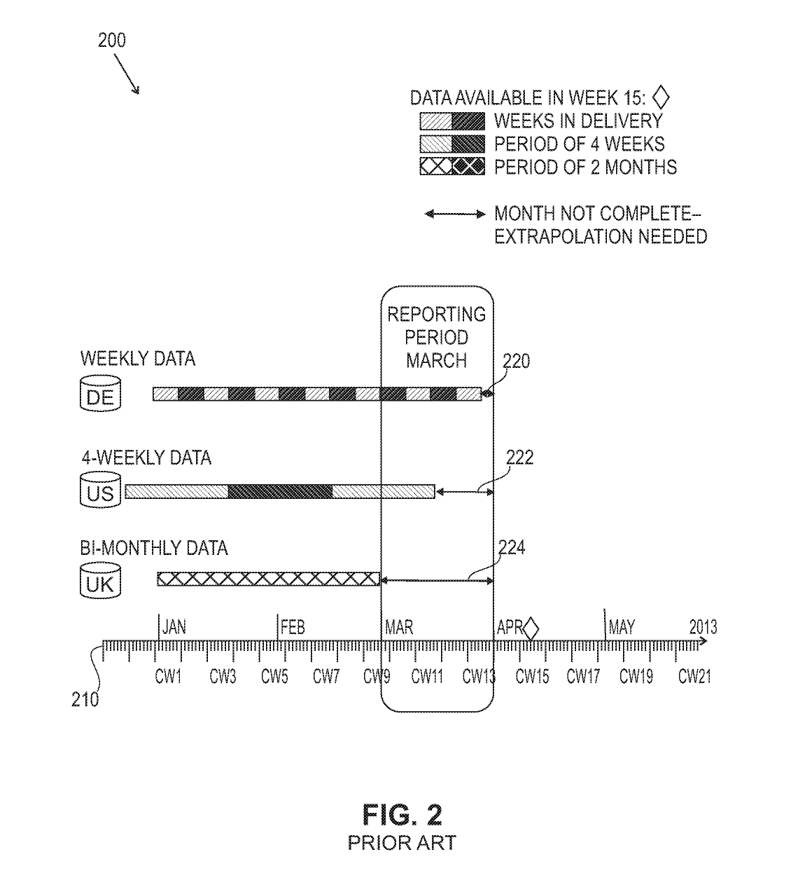

FIG. 2 depicts a conventional data aggregation timeline 200 for market research data of different databases obtained from various regions and/or countries. For illustrative purposes, time ruler 210 represents a partial calendar year depicting twenty-one calendar weeks (CW) for the months January to May. Market share data for the same product category, and from three countries of different databases with different time granularities, are depicted at the end of the first quarter of the calendar year (i.e., March 31st). First, Germany data reports weekly data twelve times a year and is current through to the end of calendar week 12. The German data follows a 5-4-4 week pattern reporting cycle (first delivery contains 5 new weeks, the next two deliveries contain 4 new weeks, and then the reporting cycle repeats). Data for the U.S. is reported on a four-weekly basis (thirteen times a year), and is current through the end of calendar week 11 (with some of the reported data overlapping to the prior year). Market research databases might provide data from the last three years starting from the most recent reporting periods. The depiction of FIG. 2 omits the prior two years and eight-nine months for simplification. Extrapolation is performed because some periods are not yet available—e.g., to report March, data needs to be extrapolated (a few days for Germany; and about a whole month for the U.S.). The data from the U.K. is reported bi-monthly (six times a year), and is current only through to the end of February (calendar week 9).

Data gap arrows 220, 222, 224 each respectively represent the data gap that needs to be filled to the end of the first calendar quarter for Germany, U.S., and U.K. As noted above, the current solution to fill these data gaps is to extrapolate market research data based on weighting factors that are the same for each database, country, and product.

To reflect seasonal deviations in product sales customer can define weighting factors manually for the corresponding periods. These weighting factors can be independent of the year or can exceptional factors can be defined for single calendar years. The weighting factors are grouped in profiles and then assigned to the data delivery agreement between the end user of RDBMS 100 and the one or more data providers 105.

With continued reference to FIG. 2, on April 12 an end user wants to generate a report for the period of March across the databases of Germany, the U.S., and the U.K., although the available data does not yet cover March for all these regions For Germany there is data missing from a few days. For U.S. market data, the last available delivery provides data through to the end of week 11, with half of March not yet reported. Accordingly, the last portion of March needs extrapolation from the U.S. data. Because U.K. data is provided on a bi-monthly basis the next delivery covering the period March/April is expected sometime in May. However that delivery is too late for global reporting across these three countries. Therefore, data for the entire month of March must be extrapolated for a report generated on April 12th to include U.K. analysis.

SAP Demand Signal Management enables you to still execute a monthly global reporting across databases by offering an extrapolation function. Missing data records or databases of poor quality can be temporarily replaced by extrapolated values until the next delivery or a corrected delivery is available.

Although only three databases are discussed, there might be hundreds of databases available to the end user. Conventionally, weighting factors can be generated automatically for each market research database using, perhaps, the time series data of one product of the delivery as a reference. To adjust the weighting factors to the most current data, an end user can regenerate the weighting factors automatically each time an extrapolation is executed during data upload. The extrapolated values can be calculated based on Equation 1.

expol_j=gew_j*(sum(sales_hist)/sum(gew_hist)) (EQ. 1)

Where:

sum(sales_hist) is the sum of all historic sales;

sum(gew_hist) is the sum of all historic weighting factors;

j is the period to be extrapolated;

gew_j is the weighting factor of the period j; and

expol_j is the extrapolated value of period j.

By using one set of weighting factors for one database, all products will get extrapolated with the same seasonal sales pattern that is described by the weighting factors. However within one database different product categories could be provided where the products have completely different seasonal deviations in sales. This leads to a negative impact on the conventional methodology.

For example, at a product level the result of conventional extrapolation might be insufficient as the pattern of the weighting factors might not reflect the seasonal deviation of the product. If all products have the same extrapolation calculation, relative key figures (e.g., market share, etc.) will not change for the extrapolated periods.

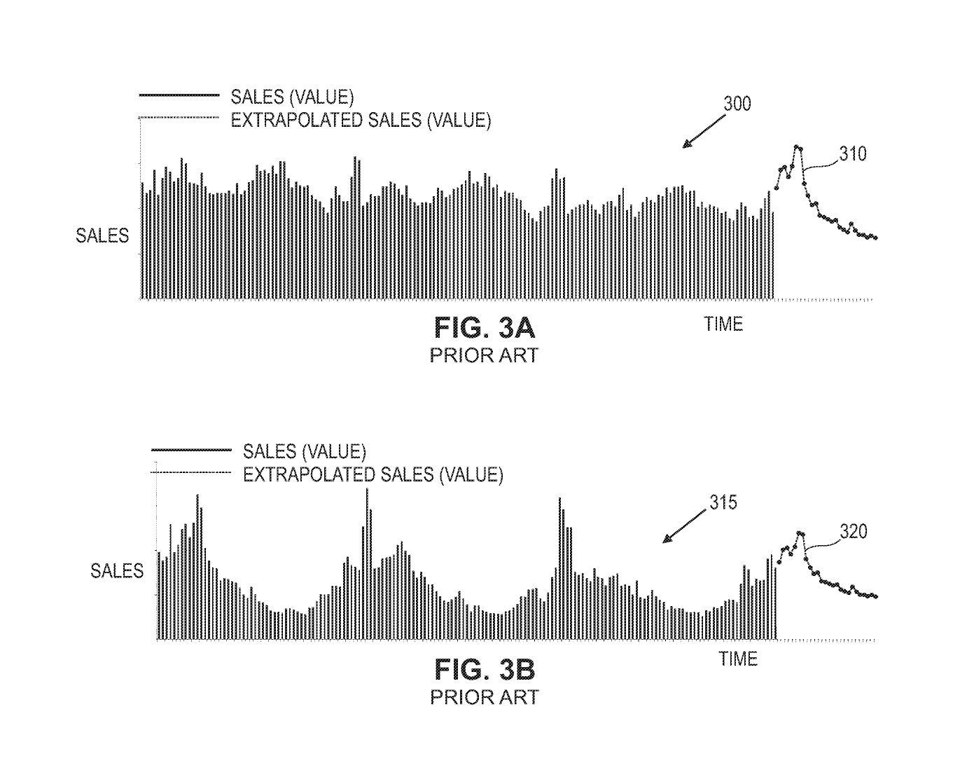

FIGS. 3A-3B depict an exemplar conventional extrapolation for two separate products from the same data base, where the extrapolation of each product used the same weighting factors. As illustrated in FIGS. 3A-3B, even though reported data curves 300, 315 have different profiles for each respective product, the extrapolated data curve 305, 320 generated for each respective product have of the same profile.

Improving the extrapolation results this conventional methodology by assigning multiple sets of weighting factors to a database for each product's individual seasonal deviations is not a valid option, as such an approach results in a huge volume of weighting factors. Such a volume will increase the total cost of database ownership, resources, and database maintenance. Moreover, the increased complexity will decrease the transparency of how extrapolation is executed.

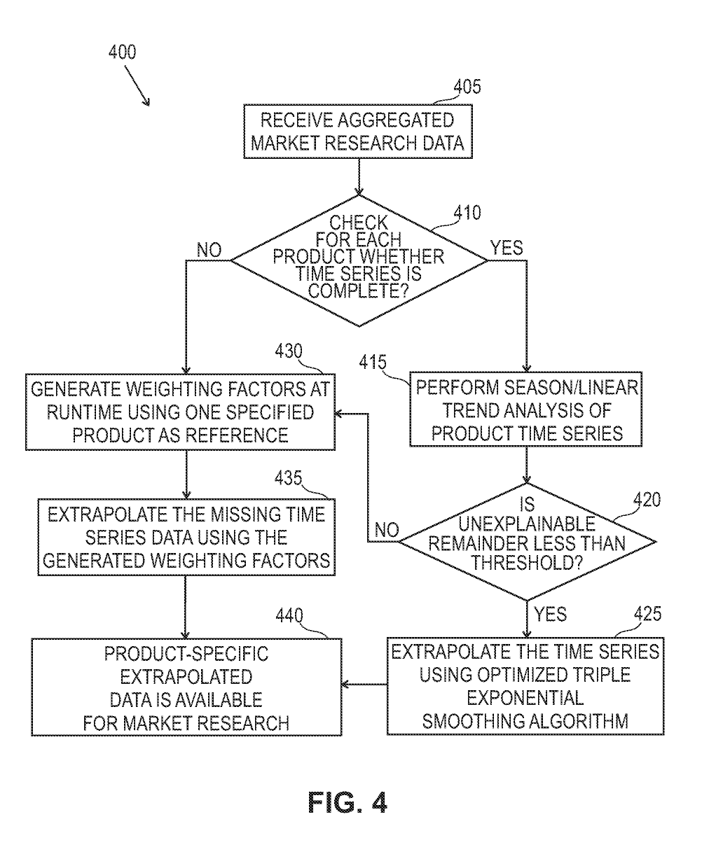

FIG. 4 depicts process 400 for extrapolating market research data in accordance with embodiments. Embodying methods provide an extrapolation for each product without any additional database resource maintenance, nor the need for persistence of large volumes of weighting factors. In overview, embodying methods provide product-specific extrapolation by first analyzing which products can get extrapolated individually by running a mathematical and/or statistical function on the product time series. In one implementation the function can be triple exponential smoothing by Holt-Winter. Second, those products identified by the analysis as not being available for such an extrapolation function receive an alternative product extrapolation.

Process 400 begins with receiving, step 405, aggregated market research data from data providers. The aggregated data for each product is checked, step 410, to determine if the time series of the product is complete. If the time series is complete, a season/linear trend analysis for this time series is performed, step 415. This trend analysis decomposes the time series value into a season component, a trend component and an unexplainable remainder. The unexplainable remainder is then compared, step 420, to a predetermined threshold. In one implementation this predetermined threshold can be 50%. If the unexplainable remainder is less than the predetermined threshold, the time series is extrapolated, step 425, using an optimized triple exponential smoothing algorithm from predictive analysis library 142.

If at step 410, a determination is made that the time series is not complete, process 400 continues to step 430. Similarly, if the unexplainable remainder is at or above the predetermined threshold (step 420), process 400 also continues to step 430. The data for these products are extrapolated with an alternative algorithm.

Create, step 430, weighting factors during run time using one product as a reference representing the overall market (e.g., the top node of the product hierarchy). These weighting factors are not persisted, so database costs and resources are not impacted beyond their use in the extrapolation. These weighting factors are created using (1) the last value of the product provided by the market data provider; and (2) the average sales over a time period for the history of the product.

Products that are not complete or cannot get explained by seasonal trend analysis get extrapolated with the same algorithm using one set of weighting factors that are generated during run time. So weighting factors are not persisted. In addition, products that can get extrapolated using exponential triple smoothing are most likely the strong products covering a high percentage of the overall sales in the market. Incomplete and unexplainable products are mostly very weak products not contributing significantly to the market. Therefore an individual extrapolation for those products are not necessary and will not increase inaccuracy of extrapolation significantly. Missing time series data is extrapolated, step 435, using the weighting factors.

The extrapolated data generated at step 425 and commonly extrapolated data using runtime weighting factors of step 435, is now available, step 430, for market research.

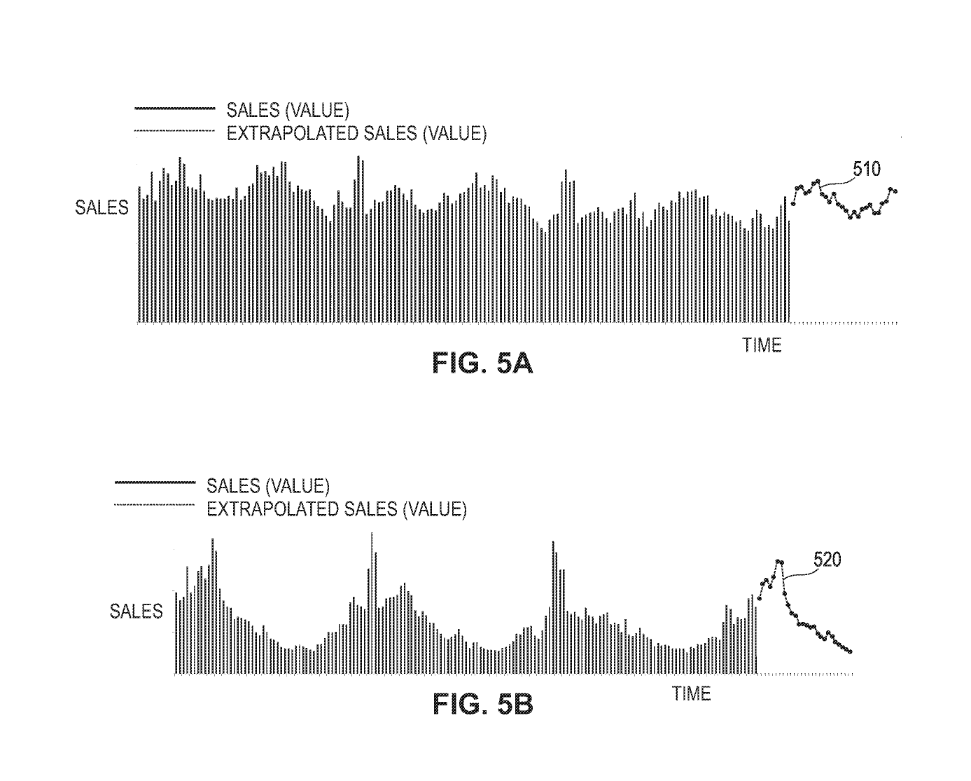

FIGS. 5A-5B depict an exemplar extrapolation result for two separate products from the same database performed by an embodying method. As can readily be observed, the profile of extrapolated data 510, and extrapolated data 520 more closely track the trend of their respective reported market data when compared to the conventional methodology extrapolation results depicted in FIGS. 3A-3B.

Embodying systems and methods provide that each product can be extrapolated with its individual season trend pattern as long as the product fulfills the above mentioned conditions. This condition is usually true for the most important products provided into the marketplace. Therefore even relative key figures (e.g., market share, etc.) will show up changes on an aggregated level for the extrapolated periods if there are any.

In accordance with some embodiments, a computer program application stored in non-volatile memory or computer-readable medium (e.g., register memory, processor cache, RAM, ROM, hard drive, flash memory, CD ROM, magnetic media, etc.) may include code or executable instructions that when executed may instruct and/or cause a controller or processor to perform methods discussed herein such as a method for extrapolating market research data time series, as described above.

The computer-readable medium may be a non-transitory computer-readable media including all forms and types of memory and all computer-readable media except for a transitory, propagating signal. In one implementation, the non-volatile memory or computer-readable medium may be external memory.

Although specific hardware and methods have been described herein, note that any number of other configurations may be provided in accordance with embodiments of the invention. Thus, while there have been shown, described, and pointed out fundamental novel features of the invention, it will be understood that various omissions, substitutions, and changes in the form and details of the illustrated embodiments, and in their operation, may be made by those skilled in the art without departing from the spirit and scope of the invention. Substitutions of elements from one embodiment to another are also fully intended and contemplated. The invention is defined solely with regard to the claims appended hereto, and equivalents of the recitations therein.

1. A method for extrapolating product time series market research data, the method comprising:
obtaining aggregated market research data from one or more regions, the aggregated market research data representing a plurality of products;
determining for at least two or more products of the plurality of products whether the market research data includes a complete time series data set;
for each of the two or more products with a complete time series data set, performing a trend analysis on the obtained market research data for a respective product; and
for each of the two or more products with an incomplete time series data set, applying one set of weighting factors at runtime.

2. The method of claim 1, including:
the trend analysis decomposing the obtained market research data for the respective product into at least an unexplainable remainder;
comparing the unexplainable remainder to a predetermined threshold; and
based on a result of the comparison step either extrapolating the time series data of the respective product using an optimized triple exponential smoothing algorithm, or creating weighting factors for the time series data of the respective product.

3. The method of claim 2, including extrapolating missing time series data for the respective product using the weighting factors.

4. The method of claim 1, wherein the completeness of the time series data set is based on a period of interest selected by an end user.

5. The method of claim 1, including extrapolating missing time series data for a respective product having an incomplete time series data set using the weighting factors.

6. The method of claim 1, including the trend analysis decomposing time series data into a season component, a trend component, and an unexplainable remainder.

7. The method of claim 1, wherein the comparison step determines if the unexplainable remainder is below the predetermined threshold.

8. The method of claim 1, the weighting factors created using the last value of the aggregated market data for a respective product and an average sales history for the respective product over a defined time period.

9. A non-transitory computer-readable medium having stored thereon instructions which when executed by a control processor of a relational database management system cause the control processor to perform a method for extrapolating product time series market research data, the method comprising:
obtaining aggregated market research data from one or more regions, the aggregated market research data representing a plurality of products;
determining for at least two or more products of the plurality of products whether the market research data includes a complete time series data set;
for each of the two or more products with a complete time series data set, performing a trend analysis on the obtained market research data for a respective product; and
for each of the two or more products with an incomplete time series data set, applying one set of weighting factors at runtime.

10. The non-transitory computer-readable medium of claim 9, the instructions further configured to cause the control processor to perform the steps of:
decomposing the obtained market research data for the respective product into at least an unexplainable remainder;
comparing the unexplainable remainder to a predetermined threshold; and
based on a result of the comparison step either extrapolating the time series data of the respective product using an optimized triple exponential smoothing algorithm, or creating weighting factors for the time series data of the respective product.

11. The non-transitory computer-readable medium of claim 10, the instructions further configured to cause the control processor to extrapolate missing time series data for the respective product using the weighting factors.

12. The non-transitory computer-readable medium of claim 9, the instructions further configured to cause the control processor to assess the completeness of the time series data set based on a period of interest selected by an end user.

13. The non-transitory computer-readable medium of claim 9, the instructions further configured to cause the control processor to extrapolate missing time series data for a respective product having an incomplete time series data set using the weighting factors.

14. The non-transitory computer-readable medium of claim 9, the instructions further configured to cause the control processor to perform the step of decomposing time series data into a season component, a trend component, and an unexplainable remainder.

15. The non-transitory computer-readable medium of claim 9, the instructions further configured to cause the control processor to determine if the unexplainable remainder is below the predetermined threshold.

16. The non-transitory computer-readable medium of claim 9, the instructions further configured to cause the control processor to create the weighting factors using the last value of the aggregated market data for a respective product and an average sales history for the respective product over a defined time period.

17. A system for extrapolating product time series market research data, the system comprising:
a relational database management system, the relational database management system including a central control processor, a predictive analysis library, and an extrapolation unit, the predictive analysis library and the extrapolation unit in communication with the central control processor across a bus of the relational database management system;
the control processor configured to access computer instructions stored in memory, the computer instructions configured to cause the control processor to:
obtain aggregated market research data from one or more regions, the aggregated market research data representing a plurality of products;
determine for at least two or more products of the plurality of products whether the market research data includes a complete time series data set;
for each of the two or more products with a complete time series data set, perform a trend analysis on the obtained market research data for a respective product; and
for each of the two or more products with an incomplete time series data set, applying one set of weighting factors at runtime.

18. The system of claim 17, the computer executable instructions further configured to cause the control processor to:
decompose the obtained market research data for the respective product into at least an unexplainable remainder;
compare the unexplainable remainder to a predetermined threshold; and
based on a result of the comparison step either extrapolate the time series data of the respective product using an optimized triple exponential smoothing algorithm, or applying weighting factors for the time series data of the respective product.

19. The system of claim 18, the computer executable instructions further configured to cause the control processor to extrapolate missing time series data for the respective product using the weighting factors.

20. The system of claim 17, the computer executable instructions further configured to cause the control processor to extrapolate missing time series data for a respective product having an incomplete time series data set using the weighting factors.
